(19) United States
(12) Patent Application Publication
(10) Pub. No.: US 2019/0095585 A1
(43) Pub. Date: Mar. 28, 2019

(54) BLOCKCHAIN BASED PROACTIVE CHROMOSOMAL DETERMINATION

(71) Applicant: International Business Machines Corporation, Armonk, NY (US)

(72) Inventors: Samuel M. Jawaharlal, Chennai (IN); Sarbajit K. Rakshit, Kolkata (IN); Sathya Santhar, Chennai (IN); Balamurugaramanathan Sivaramalingam, Paramakudi (IN)

(21) Appl. No.: 15/717,447

(22) Filed: Sep. 27, 2017

(51) Int. Cl. G06F 19/00; G06F 19/18; G06F 19/28

(52) U.S. Cl. CPC G06F 19/345; G06F 19/18; G06Q 2220/10; G06F 19/28; G06F 19/3487

(57) ABSTRACT

An example operation may include one or more of storing genetic information of a plurality of users as a plurality of respective transactions in a blockchain database, receiving a request to perform a chromosomal determination of a female user and a male user, from among the plurality of users, extracting chromosomal information of the female user and the male user from genetic information stored in the blockchain database and proactively determining genetic disorders that can occur if the female user and the male user have offspring based on the extracted chromosomal information, and outputting information about the proactively determined genetic disorders for display on a display device.

### TECHNICAL FIELD

This application generally relates to blockchain transactions, and more particularly, to blockchain based proactive chromosomal determination.

### BACKGROUND

Human cells have twenty three pairs of chromosomes. The stability of the chromosomes and the genetic information included therein can be monitored across generations to predict defects in offspring. Defective gene structures and chromosomes cause many diseases. One example is Down syndrome which is the most common chromosomal disorder. Most cases of Down syndrome result from trisomy 21, which refers to a situation in which each cell in the body has three copies of chromosome 21 instead of the usual two copies. This can be identified in a Nuchal Translucency (NT) scan which typically occurs during a pregnancy (e.g., 3^{rd} month) and identifies the symptoms of the fetus such as NT size. This fetal analysis is a reactive method. In addition, there are many other diseases associated with chromosomal disorders like Edwards' syndrome, Patau's syndrome, immunodeficiency disorders, children's hypertension, beta-thalassemia, and the like. However, at present there is no automated mechanism to proactively predict genetic defects. Instead, a couple may perform testing through a lab by giving blood or saliva and sending their fluids to the lab.

Meanwhile, a blockchain may be used as a distributed public ledger to store information such as digital assets and the like. A blockchain is a type of database that is shared, replicated, and synchronized among the members of a network. The distributed ledger records the transactions, such as the exchange of assets or data, among the participants in the network. Participants in the network govern and agree by consensus on the updates to the records in the ledger. No central, third-party mediator, such as a financial institution or clearinghouse, is involved. Every record in the distributed ledger has a timestamp and unique cryptographic signature, thus making the ledger an auditable history of all transactions in the network.

### SUMMARY

In one example embodiment, provided is a method that includes one or more of storing genetic information of a plurality of users as a plurality of respective transactions in a blockchain database, receiving a request to perform a chromosomal determination of a female user and a male user, from among the plurality of users, extracting chromosomal information of the female user and the male user from genetic information stored in the blockchain database and proactively determining genetic disorders that can occur if the female user and the male user have offspring based on the extracted chromosomal information, and outputting information about the proactively determined genetic disorders for display on a display device.

In another example embodiment, provided is a computing system that includes one or more of a storage configured to store genetic information of a plurality of users as a plurality of respective transactions in a blockchain database, a network interface configured to perform one or more of receive a request to perform a chromosomal determination of a female user and a male user, from among the plurality of users, a processor configured to extract chromosomal information of the female user and the male user from genetic information stored in the blockchain database and proactively determine genetic disorders that can occur if the female user and the male user have offspring based on the extracted chromosomal information, and an output configured to output information about the proactively determined genetic disorders for display on a display device.

A non-transitory computer readable medium having stored therein program instructions that when executed cause a computer to perform one or more of storing genetic information of a plurality of users as a plurality of respective transactions in a blockchain database, receiving a request to perform a chromosomal determination of a female user and a male user, from among the plurality of users, extracting chromosomal information of the female user and the male user from genetic information stored in the blockchain database and proactively determining genetic disorders that can occur if the female user and the male user have offspring based on the extracted chromosomal information, and outputting information about the proactively determined genetic disorders for display on a display device.

### BRIEF DESCRIPTION OF THE DRAWINGS

For a proper understanding of the examples described herein, reference should be made to the enclosed figures. It should be appreciated that the figures depict only some embodiments and are not limiting of the scope of the present disclosure.

FIG. 1 is a diagram illustrating a blockchain system for performing a proactive genetic determination in accordance with an example embodiment.

FIG. 2 is a diagram illustrating a blockchain system configuration in accordance with an example embodiment.

FIG. 3 is a diagram illustrating a sequence for performing a proactive genetic determination via a blockchain in accordance with an example embodiment.

FIG. 4 is a diagram illustrating a chromosomal determination performed by a cognitive engine in accordance with an example embodiment.

FIG. 5 is a diagram illustrating a method for performing a proactive genetic determination in accordance with an example embodiment.

FIG. 6 is a diagram illustrating a computing system for performing a proactive genetic determination in accordance with an example embodiment.

### DETAILED DESCRIPTION

It will be readily understood that the components of the present application, as generally described and illustrated in the figures herein, may be arranged and designed in a wide variety of different configurations. Thus, the following detailed description of the embodiments of at least one of a method, apparatus, non-transitory computer readable medium and system, as represented in the attached figures, is not intended to limit the scope of the application as claimed, but is merely representative of selected embodiments.

The features, structures, or characteristics as described throughout this specification may be combined in any suitable manner throughout the embodiments. In addition, the usage of the phrases such as “example embodiments”, “some embodiments”, or other similar language, throughout this specification is used to indicate that a particular feature, structure, or characteristic described in connection with the embodiment may be included in the at least one embodiment and is not to be construed as being omitted from other embodiments. Thus, appearances of the phrases “example embodiments”, “in some embodiments”, “in other embodiments”, or other similar language, may be used to refer to the same group of embodiments, and the described features, structures, or characteristics may be combined in any suitable manner in one or more embodiments.

In addition, while the term “message” may be used in the description of embodiments, the application may be applied to many types of network data, such as, packet, frame, datagram, etc. The term “message” or “request” may include packet, frame, datagram, and any equivalents thereof. Furthermore, while certain types of messages and signaling requests may be depicted in example embodiments they are not limited to a certain type of message, and the application is not limited to a certain type of signaling.

The instant application in one embodiment relates to blockchain transactions, and in another embodiment, relates to performing proactive chromosomal analysis via a blockchain system that enables authorized access to genetic information of users in anticipation of the users having children together. When a couple is considering marriage, or when a government agency is responsible for authorizing a marriage (e.g., in some jurisdictions), a chromosomal analysis may be initiated using the system described herein.

According to various aspects, a blockchain node or peer can receive and store genetic information of users within a blockchain network that is distributed among a plurality of peers. In some embodiments, the genetic information may be provided by a hospital and/or a government agency at or around the time of birth of a person. As another example, a person may be added to the blockchain at a later time by performing bloodwork and having an authenticated transaction with the blockchain via an entity such as a hospital. The blockchain peers are entry points for the blockchain network. The blockchain may be replicated across a plurality of pairs that make up the network. By storing the genetic information in a blockchain, users, authorities, governments, hospitals, corporations, and the like, may receive access to the blockchain and request that two people (e.g., male and female) have their genetic information processed to proactively determine the likelihood that the couple will have offspring with a genetic disorder. The system can be implemented in such a way that it can be transparent to the couples or can be transparent only to the authority so that they can authorize the marriage or can arrange for counselling for the couple.

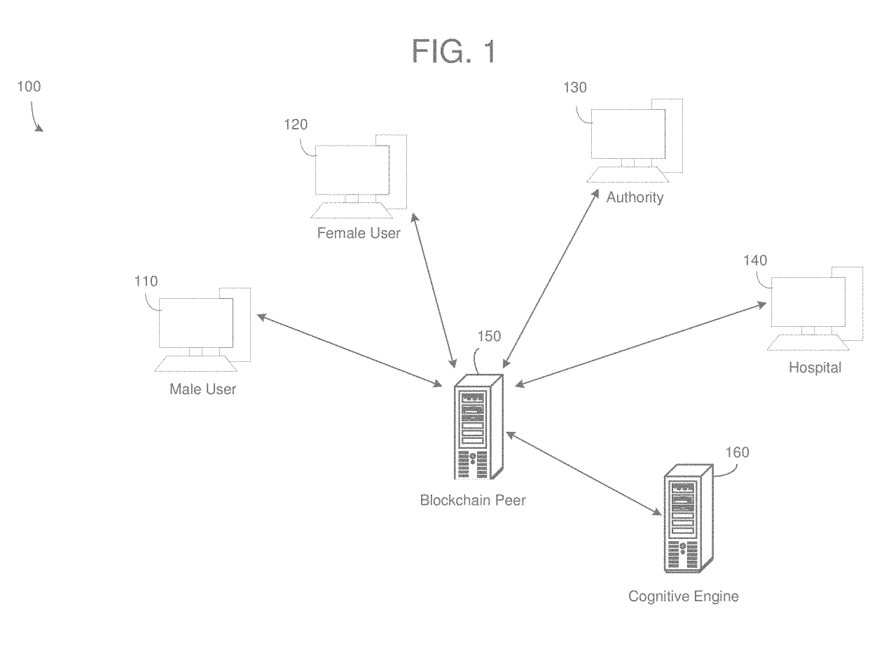

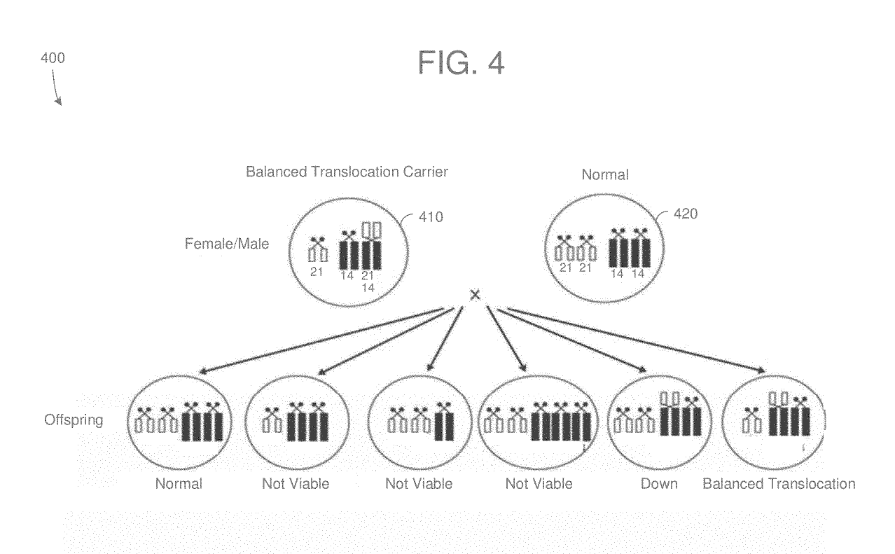

FIG. 1 illustrates a blockchain system 100 for performing a proactive genetic determination in accordance with an example embodiment. Referring to FIG. 1, the system 100 includes a plurality of devices connected to a blockchain network via a network. In this example, the blockchain network is represented by a blockchain peer 150 which stores genetic information of users as transactions in a blockchain which may be replicated across multiple blockchain peers or nodes (not shown). In this example, shown in a male user 110, a female user 120, an authority 130, and a hospital 140 which may be connected to the blockchain peer 150 via a network such as the Internet or a private network. For example, genetic information may be provided by any of the male user 110, the female user 120, the authority 130, and the hospital 140, to the blockchain peer 150. The genetic information may be analyzed by cognitive engine 160 which executes code to determine genetic disorders that can occur if the male user and the female user have offspring. In the examples herein, the cognitive engine 160 and the blockchain peer 150 are shown as separate entities, however the two entities may be incorporated together. An example of a process for proactively determining a possibility that an offspring of a couple will have genetic disorders is shown in FIG. 4 which is further described below.

According to various embodiments, when a child is born or at a subsequent time, the child relationship may be executed as a transaction in the blockchain peer 150. The transaction may be facilitated by colored coins (e.g., blue for boy and pink for girl) along with genetic metadata from the authority 130 or the hospital 140 such as genetic information about the child including a chromosomal pattern, defective chromosomes, individual inbreeding co-efficient, inherited disorders, hearing information, vision information, blood information, and the like. When a request for chromosomal analysis such as a marriage transaction is initiated by any of the male user 110, the female user 120, the authority (e.g., government, corporation, etc.) and the hospital 140, it triggers cognitive engine 160 to analyze the genetic metadata of both the male user and the female user along with a degree of consanguinity and can determine the possibility of genetic disorders if the couple has offspring. The determination can be implemented in such a way that it can be transparent to the couples (e.g., male user 110 and female user 120) or transparent only to the authority 130 or the hospital 140 so that they can authorize the marriage transaction or can arrange for counselling for the couple.

The system 100 implemented via a blockchain may be used to identify consanguineous marriages or at least notify couples of the likelihood that their offspring may be born with genetic disorders. Consanguineous marriages are typically due to inherited disorders that occur because the couple shares a common defective chromosome. It can also occur between two unrelated people who share common chromosomal defect. For example, translocations may be present in children of non-consanguineous marriage parents if t(21;21) is present in both the parents and there is 100% risk of recurrence for all their children resulting in down syndrome. As another example, if it is t(9;22), it would result in chronic myeloid leukemia (CML).

Autosomal recessive gene mutations are inherited from a common ancestor. For example, the closer the biological relationship between parents, the greater is the probability that their offspring will inherit identical copies of one or more detrimental recessive genes. For example, first cousins are predicted to share 12.5% (⅛) of their genes. When a marriage transaction is initiated by the authority 130, the authority 130 may submit a request to blockchain peer 150 which triggers the cognitive engine 160 to analyze the genetic metadata of both the couples and predict the possibility of genetic disorders if they have offspring.

The cognitive engine 160 can also be used to identify indirect impacts to future generations. For example, people with translocation, Down syndrome, etc., can inherit the condition from an unaffected parent. In this case, the parent may carry a rearrangement of genetic material between chromosome 21 and another chromosome. This rearrangement is called a balanced translocation. No genetic material may be gained or lost in a balanced translocation, so these chromosomal changes usually do not cause any health problems. However, as this translocation is passed to the next generation, it can become unbalanced. People who inherit an unbalanced translocation involving chromosome 21 may have extra genetic material from chromosome 21, which causes Down syndrome.

The cognitive engine 160 can also identify impacts to future generations in case of a balanced translocation in first generation but unbalanced translocation in the second generation which could affect grandchildren of the couple. When a chromosomal analysis transaction is initiated between two people, all the previous transactions may be tracked in sequence for one of the persons to identify the direct and indirect relationship with the other person and a relationship index may also stored in the blockchain by the blockchain peer 150 and used by cognitive engine 160 for prediction of disorders.

In some embodiments, and for example, an individual inbreeding coefficients (F) may be computed according to Wright's path method.

$$F = {\sum }_{i = 1}^{c} {( \frac{1}{2} )}^{{m}_{i} + {n}_{i} + 1} \qquad Equation 1$$

In the example of Equation 1, mᵢ and nᵢ refer to the number of paths from the ith common ancestor, and c refers to the number of common ancestors. The genealogical inbreeding coefficient for each disease may then be computed as the average of all individual F values. When the child grows and becomes an adult and when a chromosomal analysis transaction is initiated in the blockchain with another person, the cognitive engine 160 plays a vital role.

In some embodiments, the family hierarchy of a person may be maintained with their genetic information on the blockchain. Each transaction in the blockchain between a couple may represent a relationship. When a chromosomal analysis request is desired, a person A may send a colored coin to person B enabling person B to provide coins for both B and A to the blockchain peer 150 as a request for chromosomal analysis. In order to prevent false transactions, each coin/transaction can be accompanied by a smart contract which can mandate another transaction by an authorized party to happen. For example, when son or daughter coins are transferred by person A, the transaction is complete only when A possess a coin through a transaction from a hospital (where the son or the daughter was born) or by the government. This is equivalent to the approval that the government/hospital gives to A that he has a son with asset ID ####, so that only son colored coin can be transferred and only to the respective asset ID and also documents like a birth certificate, social security information, and the like, can be stored in blockchain by the blockchain peer 150.

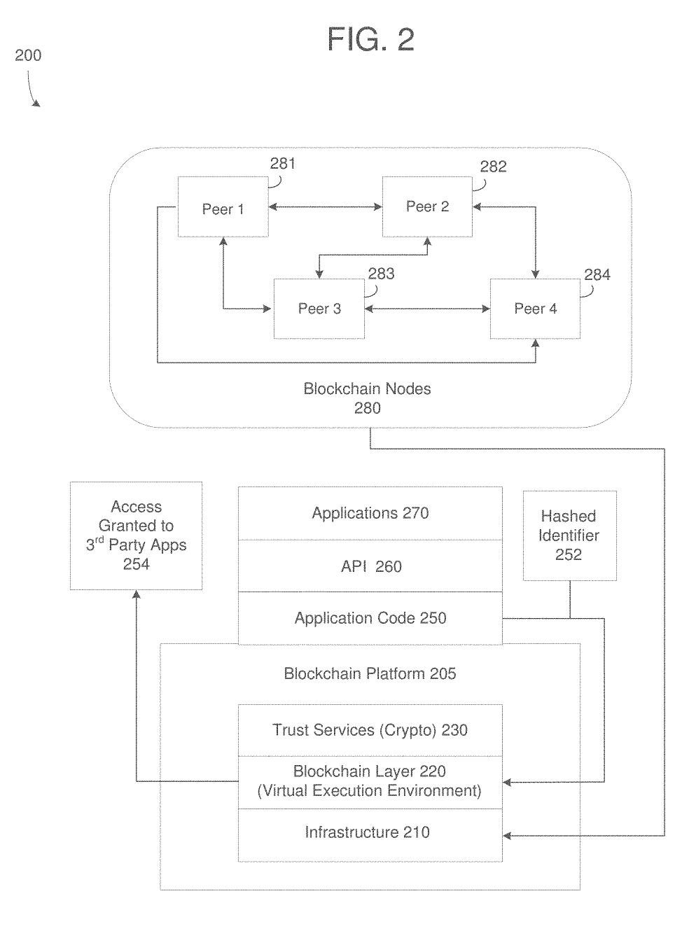

FIG. 2 illustrates a blockchain system database configuration, according to example embodiments. Referring to FIG. 2, blockchain system 200 may include certain common blockchain elements, for example, a group 280 of assigned peer blockchain nodes 281-284 which participate in blockchain transaction addition and validation process (consensus). As an example, the blockchain peer 150 shown in FIG. 1 may be one of the peer blockchain nodes 281-284, etc. Any of the blockchain peer nodes 280 may initiate a blockchain authentication and seek to write to a blockchain immutable ledger stored in blockchain layer 220, a copy of which may also be stored on the underpinning physical infrastructure 210. In this configuration, the customized blockchain configuration may include one or applications 270 which are linked to application programming interfaces (APIs) 260 to access and execute stored program/application code (e.g., chain code and/or smart contracts) 250, which are created according to the customized configuration sought by the participants and can maintain their own state, control its own assets, and receive external information. This code can be deployed as a transaction and installed, via appending to the distributed ledger, on all blockchain peer nodes.

The blockchain base or platform 205 may include various layers of blockchain data, services (e.g., cryptographic trust services, virtual execution environment), and underpinning physical computer infrastructure necessary to receive and store new transactions and provide access to auditors which are seeking to access data entries. The blockchain layer 220 may expose an interface that provides access to the virtual execution environment necessary to process the program code and engage the physical infrastructure 210. Cryptographic trust services 230 may be used to verify transactions such as asset exchange transactions and keep information private.

The blockchain configuration of FIG. 2 may process and execute program and application code 250 by way of one or more interfaces exposed, and services provided, by blockchain platform 205. The code may control blockchain assets. For example, the code can store and transfer data, and may be executed by the blockchain in the form of a smart contract and associated chain code with conditions or other code elements subject to its execution. The smart contracts 250 may be created to execute reminders, updates, and/or other notifications subject to the changes, updates, etc. As another example, as described herein, the cognitive engine 160 shown in FIG. 1 may be implemented as a smart contract. The smart contracts can themselves be used to identify rules associated with authorization and access requirements and usage. For example, hashed identifier information 252 received from a user device may be processed by one or more processing entities (virtual machines) included in the blockchain layer 220. The result may include access being granted 254 to a third party application from the blockchain computing environment (VM). In this example, the previously known user identifiers or data template information may be stored in the blockchain platform 205. The physical machines 210 may be accessed to retrieve the user device template and the information can be used to match against incoming user identifiers for verification purposes.

Within chaincode, a smart contract may be created via a high-level application and programming language, then converted to a string that is written to a block in the blockchain. The smart contract may be invoked by a user device, government authority, hospital, or the like. The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

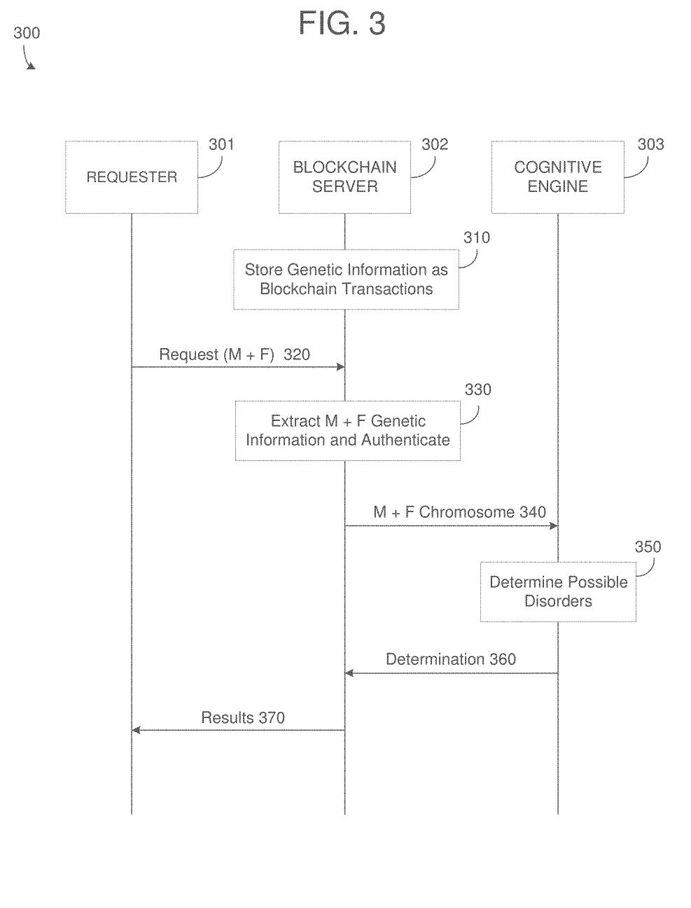

FIG. 3 illustrates a sequence 300 for performing a proactive genetic determination via a blockchain in accordance with an example embodiment. In this example, the sequence 300 is performed between a requester 301 (e.g., male user, female user, government authority, hospital, etc.), a blockchain server 302, and a cognitive engine 303. In this example, the blockchain server 302 may correspond to the blockchain peer 150 shown in FIG. 1. Referring to FIG. 3, in 310, the blockchain server 302 stores genetic information of users as blockchain transactions. For example, the genetic information may be initially populated by legal authorities, hospitals, and the like. Here, when a child is born, the hospital, government authority, or the like, may initiate the transaction in the blockchain server 302 by sending the respective colored coin (Daughter/Son) to the public address of the receiver (Father/Mother).

For example, the hospital or the government authority can provide legal approval for birth, and the hospital may provide the genetic information. Additional information may be sent to the blockchain server 302 (or stored offline and a hash thereof may be added to the blockchain). For example, the additional information may include genetic information about the child including chromosomal patterns, defective chromosomes, individual inbreeding co-efficient, inherited disorders, hearing, vision, blood, blood profile, and the like. This information can be collected by doing one time tests with blood samples by the hospital. As another example, when a person does not have their information in the blockchain server 302 during their birth and want to be part of blockchain network at a later time, legal authorities can verify the information and can initiate the transaction to the public address of the corresponding party.

In 320, the blockchain server 302 receives a request from the requester 301 with a name of potential husband and wife (or male and female). In addition, the request may be sent to the public address of the husband and wife so that two transactions may be executed in the blockchain (one from authority to Husband and one from authority to Wife with the coin property as ‘Spouse’). The request in 320 may be initiated by either the potential husband or wife, or any authorized agency such as government, hospital, or the like. When the husband or wife initiates spouse transaction to the other person (male and female), in 330, the blockchain server 302 extracts genetic information (metadata) of potential husband and wife and delivers the genetic information to cognitive engine 303 for analyzation, in 340. Here, the genetic information may include chromosomal information of both the husband and the wife such as shown in FIG. 4.

Here, FIG. 4 illustrates a process 400 of proactively determining a possibility that offspring of a couple (users 410 and 420) will have genetic disorders. In the example of FIG. 4, user 410 is a balanced translocation carrier while user 420 is normal. As a result, the offspring could be normal, not viable, have Down syndrome, or have balanced translocation. Each of these possibilities could be identified by the cognitive engine 160. In addition, although not shown in FIG. 4, a degree of confidence or a percentage of likelihood may also be provided to indicate how likely it is that a child will be conceived and will be any of normal, not viable, down syndrome, or balanced translocation.

Referring again to FIG. 3, in 350 the cognitive engine determines degree of consanguinity for husband and wife, possibility of genetic disorders, impact to future generations, and the like, and provides a result of the determinations 360 to the blockchain server 302 for storage on the blockchain and dissemination to the potential husband and wife, in 370. The cognitive engine 303 can be a separate engine which can be triggered by the blockchain server 302 whenever a request is received or a spouse transaction is initiated and the cognitive engine 303 may provide the results back to the blockchain server 302. As another example, the cognitive engine 303 can be implemented as a smart contract in the blockchain server 302. The cognitive engine 303 may receive the genetic information stored in the blockchain of both of the parties and the output is the prediction of genetic disorders with a degree of confidence.

In certain jurisdictions, the proactive genetic analysis may be used by an authority for marriage authorization or to arrange for counselling with the to-be husband/wife. The information can also be transparent to the husband and wife in such a way that the cognitive engine 303 can provide the potential impact to their offspring if they get married, or to the party who initiates the transaction. The system can also be implemented in such a way that a smart contract automatically rejects the transaction if the results from cognitive engine 303 satisfies certain predefined rules or above a threshold metric, (e.g., if there is more than 80% probability that next generation would get genetic disorders) the transaction may be automatically rejected. Although not shown in FIG. 3, the transaction including the genetic comparison results from the cognitive engine 303 may be recorded in the blockchain by the blockchain server 302.

In some jurisdictions where a marriage is not authorized by a government authority, the rejected transaction may be recorded along with a reason for rejection or a hash link to the reason. In this example, the transaction in the blockchain may get approved or rejected based on the recommendations from the cognitive engine 303. In this case, the blockchain may not be updated with the results from cognitive engine 303 but the cognitive analysis is done whenever a spouse transaction is initiated in blockchain. However, once approved, the transaction may be recorded in blockchain by the blockchain server 302 along with results from cognitive engine 303. Meanwhile, if rejected, the rejected transaction may also recorded along with reject reason or the hash link to the reject reason.

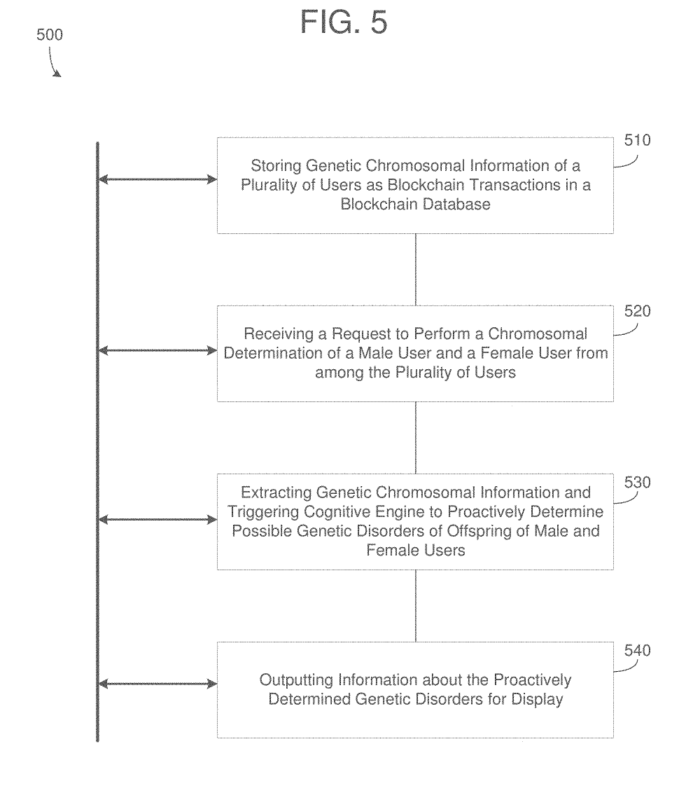

FIG. 5 illustrates a method 500 for performing a proactive genetic determination in accordance with an example embodiment. For example, the method 500 may be performed by a the blockchain peer 150 shown in FIG. 1, a combination of the blockchain peer 150 and the cognitive engine 160, or another device or group of devices such as servers, databases, user device, and the like. In 510, the method includes storing genetic information of a plurality of users as a plurality of respective transactions in a blockchain database. For example, genetic information of a user may be provided from a hospital, government, authority, a family member, or the like, when a person is born. As another example, the genetic information of a user may be provided subsequently based on a user identifying themselves such as through a birth certificate, social security card, driver's license, passport, or the like. The stored genetic information for each user may include one or more of chromosomal patterns, defective chromosomes, individual inbreeding co-efficient, inherited disorders, vision problems, hearing problems, and the like. Each user may be represented by a coin (e.g., blue for boys and pink for girls) which may be distributed to a public address of the user or the user's family when the genetic information of the user is added to the blockchain. The coin may include identification information that is unique to the user such as a hash, a password, a username, a social security number, and the like.

In 520, the method includes receiving a request to perform a chromosomal determination of a female user and a male user, from among the plurality of users. For example, the request may be a request to authorize a marriage that is received from a marriage authority or government agency. As another example, the request may be received from a user such as the female and/or male user, a hospital, or any other authorized user or corporation with access to birth records, and the like. In some embodiments, the method may further include authenticating, via the blockchain database, the female user and the male user based on respective coins assigned to the female user and the male user by an authority of the blockchain database. For example, the female user and male user may be verified based on their previously assigned coins. As another example, the users may be verified based on the hospital where they were born, a security code, a hash, and the like.

In 530, the method includes extracting chromosomal information of the female user and the male user from genetic information stored in the blockchain database and proactively determining genetic disorders that can occur if the female user and the male user have offspring based on the extracted chromosomal information. In 540, the method further includes outputting information about the proactively determined genetic disorders for display on a display device. In some embodiments, the proactively determining in 530 may include proactively determining a degree of consanguinity, a possibility of genetic disorders for child offspring, a possibility of genetic disorders for grandchildren offspring, and the like. According to various embodiments, the proactively determining may be performed by a cognitive engine that is implemented as a smart contract in the blockchain database. The cognitive engine may be included or coupled to the blockchain database or peer. As another example, the cognitive engine may be implemented within a separate entity such as a remote server, remote database, cloud platform, or the like.

In some embodiments, the method may further include generating a relationship index identifying previous relatives for one or more of the female user and the male user and storing the relationship index in the blockchain database along with respective genetic information for the one or more of the female user and the male user. Accordingly, when the proactively determining is performed the relationship index may also be evaluated to perform an additional determination for grandchildren and the like, of the potential couple. In this example, the proactively determining may include proactively determining additional genetic disorders that can occur if the female user and the male user have offspring based on the generated relationship index for the one or more of the female user and the male user.

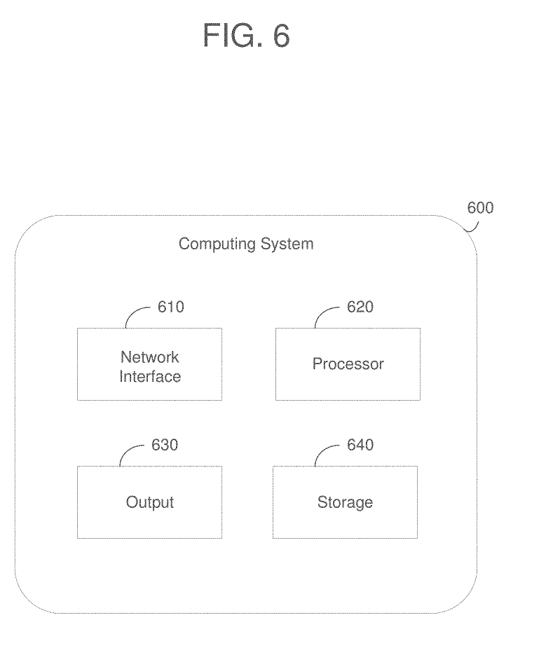

FIG. 6 illustrates a computing system 600 for performing a proactive genetic determination in accordance with an example embodiment. For example, the computing system 600 may be the blockchain peer 150 shown in FIG. 1, or another server, device, and the like. Also, the computing system 600 may perform the method 500 of FIG. 5. Referring to FIG. 6, the computing system 600 includes a network interface 610, a processor 620, an output 630, and a storage device 640. The network interface 610 may transmit and receive data via the Internet, a private network, a public network, and the like. The network interface 610 may be a wireless interface, a wired interface, or the like. The processor 620 may include one or more processing devices each including one or more processing cores. In some examples, the processor 620 is a multicore processor or a plurality of multicore processors. The output 630 may output data to an embedded display of the computing system 600, an externally connected display, a cloud platform, and the like. The storage device 640 is not limited to any kind of storage device and may include any known memory device such as RAM, ROM, hard disk, and the like. The storage 640 may store a broadcast encryption tree including a set of encryption keys for a plurality of peers that make up a blockchain network.

According to various embodiments, the storage 640 may store genetic information of a plurality of users as a plurality of respective transactions in a blockchain database. For example, each user may be represented by/assigned a unique coin of the blockchain database. The coin may include identification information that is unique to the user such as a hash, a password, a username, a social security number, and the like. The genetic information may include one or more of chromosomal patterns, defective chromosomes, individual inbreeding co-efficient, inherited disorders, and the like, for each user. The genetic information may be received by the blockchain from a hospital or government authority. As another example, the genetic information may be received from the users or the family of the users.

The network interface 610 may receive a request to perform a chromosomal determination of a female user and a male user, from among the plurality of users. For example, the request may be a marriage transaction request from a government authority or it may be from one of the users who are expecting to be married, and the like. In response to the request, the processor 630 may extract chromosomal information of the female user and the male user from genetic information stored in the blockchain database and proactively determine genetic disorders that can occur if the female user and the male user have offspring based on the extracted chromosomal information. The proactively determining may be performed by a cognitive engine that is implemented by a smart contract in the blockchain database Furthermore, the output may output information about the proactively determined genetic disorders for display on a display device. The output information may include displaying a warning or a message indicating the possibility of an offspring having a genetic disorder, a request to enter counseling, a likelihood of an offspring having a genetic disorder, and the like.

For example, the processor 620 may proactively determine a degree of consanguinity, a possibility of genetic disorders for child offspring, and a possibility of genetic disorders for grandchildren offspring. In some embodiments, the processor 620 may be further configured to authenticate the female user and the male user based on respective coins assigned to the female user and the male user by an authority of the blockchain database.

In some embodiments, the processor 620 may generate a relationship index identifying previous relatives for one or more of the female user and the male user and store the relationship index in the blockchain database along with respective genetic information for the one or more of the female user and the male user. In this example, the processor 620 may proactively determine additional genetic disorders that can occur if the female user and the male user have offspring based on the generated relationship index for the one or more of the female user and the male user.

Although an exemplary embodiment of at least one of a system, method, and non-transitory computer readable medium has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed, but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

1. A blockchain processing method, comprising:
storing genetic information of a plurality of users as a plurality of respective transactions in a blockchain database;
receiving a request to perform a chromosomal determination of a female user and a male user, from among the plurality of users;
extracting chromosomal information of the female user and the male user from genetic information stored in the blockchain database and proactively determining genetic disorders that can occur if the female user and the male user have offspring based on the extracted chromosomal information; and
outputting information about the proactively determined genetic disorders for display on a display device.

2. The blockchain processing method of claim 1, wherein the proactively determining comprises proactively determining a degree of consanguinity, a possibility of genetic disorders for child offspring, and a possibility of genetic disorders for grandchildren offspring.

3. The blockchain processing method of claim 1, wherein the proactively determining is performed by a cognitive engine that is implemented as a smart contract in the blockchain database.

4. The blockchain processing method of claim 1, wherein the stored genetic information for each user comprises one or more of chromosomal patterns, defective chromosomes, individual inbreeding co-efficient, and inherited disorders.

5. The blockchain processing method of claim 1, further comprising authenticating, via the blockchain database, the female user and the male user based on respective coins assigned to the female user and the male user by an authority of the blockchain database.

6. The blockchain processing method of claim 1, wherein the receiving comprises receiving a marriage transaction request from one or more of a government authority, a hospital, the female user, and the male user.

7. The method of claim 1, further comprising generating a relationship index identifying previous relatives for one or more of the female user and the male user and storing the relationship index in the blockchain database along with respective genetic information for the one or more of the female user and the male user.

8. The method of claim 7, wherein the proactively determining comprises proactively determining additional genetic disorders that can occur if the female user and the male user have offspring based on the generated relationship index for the one or more of the female user and the male user.

9. The method of claim 1, further comprising receiving the genetic chromosomal information of the plurality of users from one or more hospitals and storing each user as a coin in the blockchain database.

10. A blockchain computing system, comprising:
a storage configured to store genetic information of a plurality of users as a plurality of respective transactions in a blockchain database;
a network interface configured to receive a request to perform a chromosomal determination of a female user and a male user, from among the plurality of users;
a processor configured to extract chromosomal information of the female user and the male user from genetic information stored in the blockchain database and proactively determine genetic disorders that can occur if the female user and the male user have offspring based on the extracted chromosomal information; and
an output configured to output information about the proactively determined genetic disorders for display on a display device.

11. The blockchain computing system of claim 10, wherein the processor proactively determines a degree of consanguinity, a possibility of genetic disorders for child offspring, and a possibility of genetic disorders for grandchildren offspring.

12. The blockchain computing system of claim 10, wherein the processor executes a cognitive engine to perform the proactively determining, and the cognitive engine is implemented as a smart contract in the blockchain database.

13. The blockchain computing system of claim 10, wherein the storage stores genetic information for each user comprising one or more of chromosomal patterns, defective chromosomes, individual inbreeding co-efficient, and inherited disorders.

14. The blockchain computing system of claim 10, wherein the processor is further configured to authenticate the female user and the male user based on respective coins assigned to the female user and the male user by an authority of the blockchain database.

15. The blockchain computing system of claim 10, wherein the network interface is configured to receive a marriage transaction request from one or more of a government authority, a hospital, the female user, and the male user.

16. The blockchain computing system of claim 10, wherein the processor is further configured to generate a relationship index identifying previous relatives for one or more of the female user and the male user and store the relationship index in the blockchain database along with respective genetic information for the one or more of the female user and the male user.

17. The blockchain computing system of claim 16, wherein the processor proactively determines additional genetic disorders that can occur if the female user and the male user have offspring based on the generated relationship index for the one or more of the female user and the male user.

18. The blockchain computing system of claim 10, wherein the network interface is further configured to receive the genetic chromosomal information of the plurality of users from one or more hospitals and storing each user as a coin in the blockchain database.

19. A non-transitory computer readable medium having stored therein program instructions that when executed cause a computer to perform:
storing genetic information of a plurality of users as a plurality of respective transactions in a blockchain database;
receiving a request to perform a chromosomal determination of a female user and a male user, from among the plurality of users;
extracting chromosomal information of the female user and the male user from genetic information stored in the blockchain database and proactively determining genetic disorders that can occur if the female user and the male user have offspring based on the extracted chromosomal information; and
outputting information about the proactively determined genetic disorders for display on a display device.

20. The non-transitory computer readable medium of claim 19, wherein the executing of the cognitive engine proactively determines a degree of consanguinity, a possibility of genetic disorders for child offspring, and a possibility of genetic disorders for grandchildren offspring.
